(19) United States
(12) Patent Application Publication
(10) Pub. No.: US 2024/0340339 A1
(43) Pub. Date: Oct. 10, 2024

(54) PEER-TO-PEER IDENTITY VERIFICATION

(71) Applicant: Secure identity, LLC, New York, NY (US)

(72) Inventor: Justin Chang, New York, NY (US)

(21) Appl. No.: 18/591,367

(22) Filed: Feb. 29, 2024

Related U.S. Application Data
(60) Provisional application No. 63/457,117, filed on Apr. 4, 2023.

(51) Int. Cl. H04L 67/104; G06K 19/06; H04L 9/32

(52) U.S. Cl. CPC H04L 67/104; G06K 19/06037; H04L 9/3234

(57) ABSTRACT

People enrolled in an identification system use one or more electronic devices to interact with one or more electronic devices of the identification system in order to provide assertions regarding aspects of their identity stored in the identification system in a peer-to-peer fashion. The people, who may provide proof of their identity, may be able to specify the information that is to be provided, indicate how the information is to be formatted, and then provide one or more other people one or more mechanisms to access the formatted, specified information. In this way, the people may use the identification system to prove any number of different aspect of their identity to any number of different people without requiring different configurations for the different people and/or different information to be provided.

This application is a nonprovisional patent application of and claims the benefit of U.S. Provisional Patent Application No. 63/457,117, filed Apr. 4, 2023 and titled “Peer-to-Peer Identity Verification,” the disclosure of which is hereby incorporated herein by reference in its entirety.

### FIELD

The described embodiments relate generally to identity verification. More particularly, the present embodiments relate to peer-to-peer identity verification.

### BACKGROUND

There are many situations where a person or other entity may desire to verify a person's identity and/or aspects thereof. For example, a person hiring a plumber may verify that the plumber is licensed and bonded. By way of another example, a person hiring a nanny may verify that the nanny has more than five years of experience in the field. In still another example, a person selling a house may verify that a buyer has sufficient financial resources to purchase the house before accepting an offer.

### SUMMARY

The present disclosure relates to peer-to-peer identity verification. People enrolled in the identification system use one or more electronic devices to interact with one or more electronic devices of the identification system in order to provide assertions regarding aspects of their identity stored in the identification system in a peer-to-peer fashion. The people, who may provide proof of their identity, may be able to specify the information that is to be provided, indicate how the information is to be formatted, and then provide one or more other people one or more mechanisms to access the formatted, specified information. In this way, the people may use the identification system to prove any number of different aspects of their identity to any number of different people without requiring different configurations for the different people and/or different information to be provided.

In various embodiments, an identification system electronic device includes a non-transitory storage medium that stores instructions and a processor. The processor executes the instructions to verify identity information for a person; receive a request to generate an attestation for the person from an attesting device; upon identifying the person using information received from the attesting device, generate the attestation using a portion of the identity information specified in the request; and provide the attestation.

In some examples, the processor further executes the instructions to provide the attestation to the attesting device. In a number of examples, the processor further executes the instructions to provide a reference to the attestation to the attesting device and the attestation to a reader device that communicates with the processor using the reference. In various examples, the request specifies a format for the attestation. In some examples, the attestation includes at least one of a license status of the person, an education status of the person, a certification status of the person, or an insurance status of the person.

In a number of examples, the processor further executes the instructions to determine whether to authorize the attesting device to provide the attestation stored by the attesting device in response to an authorization request. In some implementations of such examples, the processor further executes the instructions to determine to authorize the attesting device to provide the attestation stored by the attesting device upon determining that the attestation is up to date. In various implementations of such examples, the processor further executes the instructions to generate an updated attestation upon determining that the attestation is out of date in response to the authorization request. In a number of implementations of such examples, the processor further executes the instructions to provide the updated attestation to the attesting device. In various implementations of such examples, the processor further executes the instructions to authorize the attesting device to provide the updated attestation in response to the authorization request.

In some embodiments, an attesting device includes a non-transitory storage medium that stores instructions and a processor. The processor executes the instructions to submit a request to generate an attestation for a person to an identification system electronic device that maintains identity information for the person, the request specifying a portion of the identity information; receive a response from the identification system electronic device that enables access to the attestation; and provide the access to the attestation using the response.

In a number of examples, the processor provides the access to the attestation by providing the attestation to a reader device. In various implementations of such examples, the processor provides the attestation to the reader device in response to a communication from the reader device. In some implementations of such examples, the communication is a near field communication tap.

In various examples, the processor further executes the instructions to provide the access to the attestation by providing a reference to the attestation to a reader device. In some implementations of such examples, the reference is a quick response code.

In various examples, the processor further executes the instructions to format the attestation using the portion of the identity information included in the response.

In a number of embodiments, a reader device includes a non-transitory storage medium that stores instructions and a processor. The processor executes the instructions to communicate with an attesting device; receive an attestation for a person generated, in response to a request from the attesting device, by an identification system electronic device that maintains verified identity information for the person, the request specifying a portion of the verified identity information to include in the attestation; and output the attestation.

In various examples, the processor further executes the instructions to receive the attestation from the attesting device. In some examples, the processor further executes the instructions to receive a reference to the attestation from the attesting device and uses the reference to obtain the attestation from the identification system electronic device.

### BRIEF DESCRIPTION OF THE DRAWINGS

The disclosure will be readily understood by the following detailed description in conjunction with the accompanying drawings, wherein like reference numerals designate like structural elements.

FIG. 1 depicts an example system for peer-to-peer identity verification.

FIG. 2 is a flow chart illustrating a first example method for peer-to-peer identity verification. The method may be performed by the system of FIG. 1.

FIG. 3 is a flow chart illustrating a second example method for peer-to-peer identity verification. The method may be performed by the system of FIG. 1.

FIG. 4 is a flow chart illustrating a third example method for peer-to-peer identity verification. The method may be performed by the system of FIG. 1.

FIG. 5 is a flow chart illustrating a fourth example method for peer-to-peer identity verification. The method may be performed by the system of FIG. 1.

FIG. 6 is a flow chart illustrating a fifth example method for peer-to-peer identity verification. The method may be performed by the system of FIG. 1.

FIG. 7 is a flow chart illustrating a sixth example method for peer-to-peer identity verification. The method may be performed by the system of FIG. 1.

FIG. 8 is a flow chart illustrating a seventh example method for peer-to-peer identity verification. The method may be performed by the system of FIG. 1.

FIG. 9 is a flow chart illustrating an eighth example method for peer-to-peer identity verification. The method may be performed by the system of FIG. 1.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

The description that follows includes sample systems, apparatuses, methods, and computer program products that embody various elements of the present disclosure. However, it should be understood that the described disclosure may be practiced in a variety of forms in addition to those described herein.

Traditional methods of verifying identity and/or aspects of identity such as verifying physical identification (like driver's licenses, state identification cards, federal identification cards, military identification cards, passports, and so on) become much more challenging when interactions are moved to the technological environment of a computer network. These problems are exacerbated when aspects of identity (such as occupational qualifications, financial resources, and so on) are not reflected in typical physical identification. Due to these additional challenges, verifying identity and/or aspects of identity in a computer network environment is a technical problem caused by the technological shift of interactions to the technological environment of a computer network.

Identification systems may collect and/or verify information about identities of people and/or aspects thereof (such as names, ages, addresses, emails, phone numbers, medical information, employment histories and/or qualifications, professional licenses or statuses, financial resources, and so on). These identification systems may be configured to provide one or more attestations to one or more people and/or entities regarding such identities and/or other identity information stored in association with such identities. These identification systems may also be configured to identify people (such as by receiving one or more digital representations of one or more biometrics and comparing such against biometric data stored in association with the identities, receiving logins and passwords and/or other credentials and comparing such against credentials stored in association with the identities, receiving information that only the person corresponding to the identity would know, and so on) and perform one or more actions using identity information associated with the identified identity. Such identification systems may provide a technical solution to the technical problem of the challenges to traditional methods of verifying identity and/or aspects of identity such as verifying physical identification caused by the technological shift of interactions to the technological environment of a computer network.

However, a person or entity may need to be configured to access the identification system in order to obtain one or more attestations regarding the identity and/or identity information of one or more people. Further, the identification system may need to be configured to provide one or more assertions regarding the precise identity aspects desired in the format desired. For example, a person may desire an assertion regarding previous jobs that a contractor has completed but the identification system may be configured to verify that the contractor is the person that the contractor asserts himself to be. Alternatively, the person may not be configured to use the identification system at all and may need to be configured to do so. Such configuration may be burdensome, require additional hardware and/or software resources, require additional hardware and/or software processing time or resources, not be compatible with existing systems, and so on. The ability to rely on identity verification provided by such identification systems without requiring such configuration would reduce such burdens, allow incompatible systems to be used without modification or replacement, eliminate redundant components, improve the operation of computing systems by reducing required hardware and/or software resources, and so on.

One such technical solution to the above technical problem is to enable people enrolled in the identification system to use one or more electronic devices to interact with one or more electronic devices of the identification system in order to provide assertions regarding aspects of their identity stored in the identification system in a peer-to-peer fashion. The people, who may provide proof of their identity, may be able to specify the information that is to be provided, indicate how the information is to be formatted, and then provide one or more other people one or more mechanisms to access the formatted, specified information. In this way, the people may use the identification system to prove any number of different aspects of their identity to any number of different people without requiring different configurations for the different people and/or different information to be provided.

This allows performance of functions that were previously not performable and enables more efficiency while expending less work, eliminating unnecessary hardware and/or other components, and more efficiently using hardware, software, network, and/or other resources. This may improve the operation of systems involved by reducing unnecessary components, increasing the speed at which the systems perform operations, and/or reducing consumption of hardware, software, network, and/or other resources.

The present disclosure relates to peer-to-peer identity verification. People enrolled in the identification system use one or more electronic devices to interact with one or more electronic devices of the identification system in order to provide assertions regarding aspects of their identity stored in the identification system in a peer-to-peer fashion. The people, who may provide proof of their identity, may be able to specify the information that is to be provided, indicate how the information is to be formatted, and then provide one or more other people one or more mechanisms to access the formatted, specified information. In this way, the people may use the identification system to prove any number of different aspects of their identity to any number of different people without requiring different configurations for the different people and/or different information to be provided.

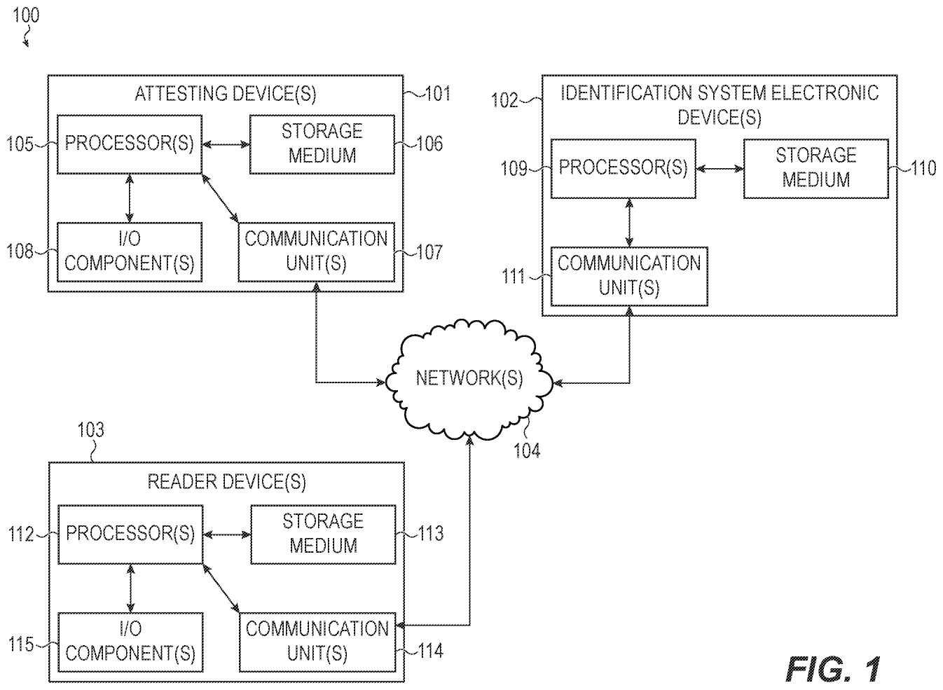

These and other embodiments are discussed below with reference to FIGS. 1-9. However, those skilled in the art will readily appreciate that the detailed description given herein with respect to these Figures is for explanatory purposes only and should not be construed as limiting.

FIG. 1 depicts an example system 100 for peer-to-peer identity verification. The system 100 may include one or more attesting devices 101, identification system electronic devices 102, and/or reader devices 103 that are operable to communicate with each other via one or more wired and/or wireless communication networks.

People may use the attesting device 101 to interact with the identification system electronic device 102 in order to provide assertions regarding aspects of their identity to the reader device 103 in a peer-to-peer fashion. The people, who may provide proof of their identity to the identification system electronic device 102 via the attesting device 101, may be able to use the attesting device 101 to specify the information that is to be provided, indicate how the information is to be formatted, and then provide to the reader device 103 one or more mechanisms to access the formatted, specified information. In this way, the people may use the system 100 to prove any number of different aspects of their identity to any number of different people without requiring different configurations for the different people and/or different information to be provided.

This allows performance of functions that were previously not performable and enables more efficiency while expending less work, eliminating unnecessary hardware and/or other components, and more efficiently using hardware, software, network, and/or other resources. This may improve the operation of the system 100 and/or components thereof by reducing unnecessary components, increasing the speed at which the system 100 and/or components thereof perform operations, and/or reducing consumption of hardware, software, network, and/or other resources.

In some examples, the attesting device 101 may receive the formatted attestation from the identification system electronic device 102 and provide such to the reader device 103 upon request. In various implementations of such examples, the attesting device 101 may request permission from the identification system electronic device 102 prior to providing the stored formatted attestation, which the identification system electronic device 102 may deny if the formatted attestation uses outdated information (and/or the identification system electronic device 102 may provide an updated formatted attestation to use instead that reflects the updated information).

In other examples, the attesting device 101 may receive a reference (such as a quick response or “QR” code) to the formatted attestation that the attesting device 101 may provide to the reader device 103 and the reader device 103 may use to communicate with the identification system electronic device 102 and/or another device to access the formatted attestation (which may be updated when the reference is used).

In still other examples, the identification system electronic device 102 may provide the requested attestation, but may not format the attestation. In such an example, the attesting device 101 and/or another device may instead format the received attestation. Various configurations are possible and contemplated without departing from the scope of the present disclosure.

In various implementations, the identification system electronic device 102 may verify identity information for a person (such as verifying that the person is who the person asserts to be, verifying that their contact information is correct, ascertaining professional license statuses for the person, collecting and/or verifying biometric data, and/or collecting and/or verifying any other information associated with the identity of the person); receive a request to generate an attestation for the person from the attesting device 101; upon identifying the person using information received from the attesting device 101 (such as one or more digital representations of biometrics that may be compared against stored biometric data, passwords and/or other credentials that may be compared against stored credentials, and so on), generate the attestation using a portion of the identity information specified in the request; and provide the attestation.

In some examples, the identification system electronic device 102 provides the attestation to the attesting device 101. In a number of examples, the identification system electronic device 102 provides a reference (such as a QR code, a link, and/or other mechanism) to the attestation to the attesting device 101 and provides the attestation to a reader device 103 that communicates with the identification system electronic device 102 using the reference. In various examples, the request specifies a format for the attestation. In some examples, the attestation includes at least one of: a license status of the person, an education status of the person, a certification status of the person, or an insurance status of the person.

In various examples, the identification system electronic device 102 determines whether to authorize the attesting device to provide the attestation stored by the attesting device 101 in response to an authorization request. In a number of such examples, the identification system electronic device 102 determines to authorize the attesting device 101 to provide the attestation stored by the attesting device upon determining that the attestation is up to date. In various such examples, the identification system electronic device 102 generates an updated attestation upon determining that the attestation is out of date in response to the authorization request. In some such examples, the identification system electronic device 102 provides the updated attestation to the attesting device. In a number of such examples, the identification system electronic device 102 authorizes the attesting device 101 to provide the updated attestation in response to the authorization request.

In some implementations, the attesting device 101 may submit a request to generate an attestation for a person to an identification system electronic device that maintains identity information for the person, the request specifying a portion of the identity information; receive a response from the identification system electronic device that enables access to the attestation; and provide the access to the attestation using the response.

In various examples, the attesting device 101 provides the access to the attestation by providing the attestation to the reader device 103. In some such examples, the attesting device 101 provides the attestation to the reader device in response to a communication from the reader device. In a number of such examples, the communication is a near field communication tap. In other examples, the communication may be a Bluetooth™ communication, a text message, and so on.

In some examples, the attesting device 101 provides the access to the attestation by providing a reference to the attestation to the reader device 103. In a number of such examples, the reference is a quick response code. In various examples, the attesting device 101 formats the attestation using the portion of the identity information included in the response.

In a number of implementations, the reader device 103 may communicate with the attesting device 101; receive an attestation for a person generated, in response to a request from the attesting device 101, by the identification system electronic device 102 that maintains verified identity information for the person, the request specifying a portion of the verified identity information to include in the attestation; and output the attestation.

In various examples, the reader device 103 receives the attestation from the attesting device 101. In some examples, the reader device 103 receives a reference to the attestation from the attesting device 101 and uses the reference to obtain the attestation from the identification system electronic device 102.

The identification system electronic device 102 may store identity information (such as one or more names, addresses, telephone numbers, social security numbers, patient identification numbers or other identifiers, insurance data, financial data, health information (such as one or more temperatures, pupil dilation, medical diagnoses, immunocompromised conditions, medical histories, medical records, infection statuses, vaccinations, immunology data, results of antibody tests evidencing that a person has had a particular communicable illness and recovered, blood test results, saliva test results, and/or the like), and so on) associated with the identities of people (which may be verified identities, where the identities are verified as corresponding to the particular person named and/or where the identity information is verified as valid). Alternatively and/or additionally, some or all of the health information may be stored separately from the identity information but otherwise associated with the identity information, such as in a Health Insurance Portability and Accountability Act (“HIPAA”) compliant or other data store or enclave. Such a data store or enclave may be stored on one or more different storage media than the identity information, or may be stored on the same storage medium or media and logically isolated from the identity information. The health information may be simultaneously and/or substantially simultaneously accessible as the identity information, such as where the identity information includes a health information identifier or key that may be used to access the separately stored health information. The identification system electronic device 102 may control access to the identity information and/or the health information using identification information that is associated with the identity information. The identification information may include biometric data (which may include one or more digital representations of one or more fingerprints, blood vessel scans, palm-vein scans, voiceprints, facial images, retina images, iris images, deoxyribonucleic acid sequences, heart rhythms, gaits, and so on), one or more logins and/or passwords, authorization tokens, social media and/or other accounts, and so on. In various implementations, the identification system electronic device 102 may allow the person associated with an identity to control access to the identity information, the health information, and/or other information (such as payment account information, health information (such as medical records, HIPAA protected information in order to be compliant with various legal restrictions, and so on), contact information), and so on. The identification system electronic device 102 may control access to such information according to input received from the person. The identification system electronic device 102 may be operable to communicate with a station in order to handle requests to provide the identity information and/or the health information, update and/or otherwise add to the identity information and/or the health information, provide attestations regarding and/or related to the identity information and/or the health information (such as whether or not a person is of a particular age, whether or not a person has a particular license or insurance policy, whether or not a person has been monitored as having particular health information, whether or not a person has had a particular vaccination, whether or not an antibody test evidences that a person has had a particular communicable illness and recovered, whether or not a person has a particular ticket or authorization, whether or not a person has been monitored as having particular antibodies, whether or not a person has been assigned a particular medical diagnosis, and so on), evaluate health information stored in the identity information and/or otherwise associated with the identity information and/or other information stored in the identity information, perform transactions, allow or deny access, route one or more persons, and/or perform one or more other actions.

The identification system electronic device 102 may be any kind of electronic device and/or cloud and/or other computing arrangement. Examples of such devices include, but are not limited to, one or more desktop computing devices, laptop computing devices, mobile computing devices, wearable devices, tablet computing devices, mobile telephones, kiosks and/or other stations, smart phones, printers, displays, vehicles, kitchen appliances, entertainment system devices, digital media players, and so on. The identification system electronic device 102 may include one or more processors 109 and/or other processing units or controllers, communication units 111 (such as one or more network adapters and/or other devices used by a device to communicate with one or more other devices), non-transitory storage media 110, and/or other components. The processor 109 may execute one or more sets of instructions stored in the non-transitory storage media 110 to perform various functions, such as receiving and/or storing biometric data and/or other identification information, receiving and/or storing identity information and/or health information, matching one or more received digital representations of biometrics and/or other identification information to stored data, retrieving identity information and/or health information associated with stored data matching one or more received digital representations of biometrics and/or other identification information, providing retrieved identity information and/or health information, communicating via the network 104 using the communication unit, and so on. Alternatively and/or additionally, the identification system electronic device 102 may involve one or more memory allocations configured to store at least one executable asset and one or more processor allocations configured to access the one or more memory allocations and execute the at least one executable asset to instantiate one or more processes and/or services, such as one or more gallery management services, biometric identification services, and so on.

Similarly, the attesting device 101 may be any kind of device. The attesting device 101 may include one or more processors 105 and/or other processing units and/or controllers, one or more non-transitory storage media 106 (which may take the form of, but is not limited to, a magnetic storage medium; optical storage medium; magneto-optical storage medium; read only memory; random access memory; erasable programmable memory; flash memory; and so on), one or more communication units 107, one or more health sensors (such as a thermometer and/or other thermal sensor, a blood pressure sensor, a blood test sensor, a blood vessel scanner, a palm-vein scanner, a still image and/or video camera, a 2D and/or 3D image sensor, a saliva sensor, a breath sensor, a deoxyribonucleic acid sensor, a heart rhythm monitor, a microphone, sweat sensors, and so on), one or more biometric readers (such as a fingerprint scanner, a blood vessel scanner, a palm-vein scanner, an optical fingerprint scanner, a phosphorescent fingerprint scanner, a still image and/or video camera, a 2D and/or 3D image sensor, a capacitive sensor, a saliva sensor, a deoxyribonucleic acid sensor, a heart rhythm monitor, a microphone, and so on), one or more input and/or output components 108 (such as one or more displays, buttons, track pads, touch screens, speakers, microphones, and so on), and/or one or more other components. The processor 105 may execute one or more sets of instructions stored in the non-transitory storage media 106 to perform various functions, such as using the biometric reader to obtain one or more digital representations of one or more biometrics (such as a digital representation of a fingerprint, a blood vessel scan, a palm-vein scan, a voiceprint, a facial image, a retina image, an iris image, a deoxyribonucleic acid sequence, a heart rhythm, a gait, and so on) for a person, obtaining health information for a person using the health sensor, communicating via the network 104 using the communication unit 107, and so on.

Likewise, the reader device 103 may be any kind of device. The reader device 103 may include one or more processors 112 and/or other processing units and/or controllers, one or more non-transitory storage media 113 (which may take the form of, but is not limited to, a magnetic storage medium; optical storage medium; magneto-optical storage medium; read only memory; random access memory; erasable programmable memory; flash memory; and so on), one or more communication units 114, one or more input and/or output components 115 (such as one or more displays, buttons, track pads, touch screens, speakers, microphones, and so on), and/or one or more other components. The processor 112 may execute one or more sets of instructions stored in the non-transitory storage media 113 to perform various functions, such as communicating via the network 104 using the communication unit 114, communicating with the attesting device 101, and so on.

As used herein, the term “computing resource” (along with other similar terms and phrases, including, but not limited to, “computing device” and “computing network”) refers to any physical and/or virtual electronic device or machine component, or set or group of interconnected and/or communicably coupled physical and/or virtual electronic devices or machine components, suitable to execute or cause to be executed one or more arithmetic or logical operations on digital data.

Example computing resources contemplated herein include, but are not limited to: single or multi-core processors; single or multi-thread processors; purpose-configured co-processors (e.g., graphics processing units, motion processing units, sensor processing units, and the like); volatile or non-volatile memory; application-specific integrated circuits; field-programmable gate arrays; input/output devices and systems and components thereof (e.g., keyboards, mice, track pads, generic human interface devices, video cameras, microphones, speakers, and the like); networking appliances and systems and components thereof (e.g., routers, switches, firewalls, packet shapers, content filters, network interface controllers or cards, access points, modems, and the like); embedded devices and systems and components thereof (e.g., system(s)-on-chip, Internet-of-Things devices, and the like); industrial control or automation devices and systems and components thereof (e.g., programmable logic controllers, programmable relays, supervisory control and data acquisition controllers, discrete controllers, and the like); vehicle or aeronautical control devices and systems and components thereof (e.g., navigation devices, safety devices or controllers, security devices, and the like); corporate or business infrastructure devices or appliances (e.g., private branch exchange devices, voice-over internet protocol hosts and controllers, end-user terminals, and the like); personal electronic devices and systems and components thereof (e.g., cellular phones, tablet computers, desktop computers, laptop computers, wearable devices); personal electronic devices and accessories thereof (e.g., peripheral input devices, wearable devices, implantable devices, medical devices and so on); and so on. It may be appreciated that the foregoing examples are not exhaustive.

Example information can include, but may not be limited to: personal identification information (e.g., names, social security numbers, telephone numbers, email addresses, physical addresses, driver's license information, passport numbers, and so on); identity documents (e.g., driver's licenses, passports, government identification cards or credentials, and so on); protected health information (e.g., medical records, dental records, and so on); financial, banking, credit, or debt information; third-party service account information (e.g., usernames, passwords, social media handles, and so on); encrypted or unencrypted files; database files; network connection logs; shell history; filesystem files; libraries, frameworks, and binaries; registry entries; settings files; executing processes; hardware vendors, versions, and/or information associated with the compromised computing resource; installed applications or services; password hashes; idle time, uptime, and/or last login time; document files; product renderings; presentation files; image files; customer information; configuration files; passwords; and so on. It may be appreciated that the foregoing examples are not exhaustive.

The foregoing examples and description of instances of purpose-configured software, whether accessible via API as a request-response service, an event-driven service, or whether configured as a self-contained data processing service are understood as not exhaustive. In other words, a person of skill in the art may appreciate that the various functions and operations of a system such as described herein can be implemented in a number of suitable ways, developed leveraging any number of suitable libraries, frameworks, first or third-party APIs, local or remote databases (whether relational, NoSQL, or other architectures, or a combination thereof), programming languages, software design techniques (e.g., procedural, asynchronous, event-driven, and so on or any combination thereof), and so on. The various functions described herein can be implemented in the same manner (as one example, leveraging a common language and/or design), or in different ways. In many embodiments, functions of a system described herein are implemented as discrete microservices, which may be containerized or executed/instantiated leveraging a discrete virtual machine, that are only responsive to authenticated API requests from other microservices of the same system. Similarly, each microservice may be configured to provide data output and receive data input across an encrypted data channel. In some cases, each microservice may be configured to store its own data in a dedicated encrypted database; in others, microservices can store encrypted data in a common database; whether such data is stored in tables shared by multiple microservices or whether microservices may leverage independent and separate tables/schemas can vary from embodiment to embodiment. As a result of these described and other equivalent architectures, it may be appreciated that a system such as described herein can be implemented in a number of suitable ways. For simplicity of description, many embodiments that follow are described in reference to an implementation in which discrete functions of the system are implemented as discrete microservices. It is appreciated that this is merely one possible implementation.

As described herein, the term “processor” refers to any software and/or hardware-implemented data processing device or circuit physically and/or structurally configured to instantiate one or more classes or objects that are purpose-configured to perform specific transformations of data including operations represented as code and/or instructions included in a program that can be stored within, and accessed from, a memory. This term is meant to encompass a single processor or processing unit, multiple processors, multiple processing units, analog or digital circuits, or other suitably configured computing element or combination of elements.

Although the system 100 is illustrated and described as including the attesting device 101, the identification system electronic device 102, and the reader device 103, it is understood that this is an example. In other implementations, other arrangements of the same, similar, and/or different components may be used without departing from the scope of the present disclosure. For example, in some implementations, one or more of the attesting device 101, the identification system electronic device 102, and the reader device 103 may be omitted. Various configurations are possible and contemplated without departing from the scope of the present disclosure.

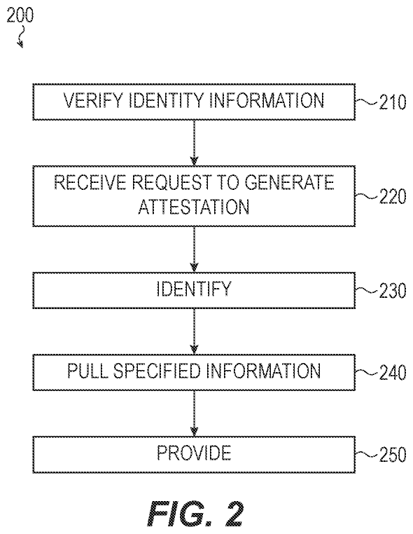

FIG. 2 is a flow chart illustrating a first example method 200 for peer-to-peer identity verification. The method 200 may be performed by the system 100 of FIG. 1.

At operation 210, an electronic device (such as the identification system electronic device 102 of FIG. 1) may verify identity information for a person. Verifying the identity information for the person may include verifying that the person is who the person asserts to be, verifying that their contact information is correct, ascertaining professional license statuses for the person, collecting and/or verifying biometric data, and/or collecting and/or verifying any other information associated with the identity of the person.

At operation 220, the electronic device may receive one or more requests to generate one or more attestations. Such a request may be received from one or attesting devices.

At operation 230, the electronic device may identify the person who submitted the request. Identifying the person may include using one or more digital representations of biometrics that may be compared against stored biometric data, passwords and/or other credentials that may be compared against stored credentials, and so on.

At operation 240, the electronic device may pull the specified information. The specified information may be pulled from one or more databases and/or other data stores.

At operation 250, the electronic device may provide the pulled information. The electronic device may provide the pulled information to the device that submitted the request, another device that uses a reference to the pulled information that the electronic device provided to the device that submitted the request, and so on.

In various examples, this example method 200 may be implemented using a group of interrelated software modules or components that perform various functions discussed herein. These software modules or components may be executed within a cloud network and/or by one or more computing devices, such as the attesting device 101, the identification system electronic device 102, and/or the reader device 103 of FIG. 1.

Although the example method 200 is illustrated and described as including particular operations performed in a particular order, it is understood that this is an example. In various implementations, various orders of the same, similar, and/or different operations may be performed without departing from the scope of the present disclosure.

For example, the method 200 may include the additional operation of formatting the pulled information. The electronic device may format the pulled information according to one or more formatting specifications provided by the device that submitted the request. Various configurations are possible and contemplated without departing from the scope of the present disclosure.

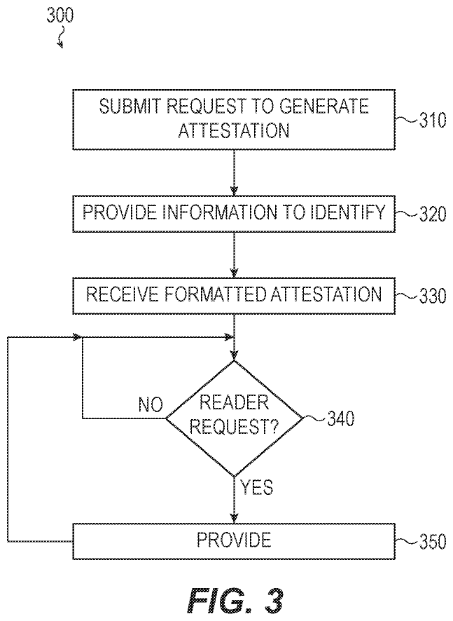

FIG. 3 is a flow chart illustrating a second example method 300 for peer-to-peer identity verification. The method 300 may be performed by the system 100 of FIG. 1.

At operation 310, an electronic device (such as the attesting device 101 of FIG. 1) may submit one or more requests to generate one or more attestations. The electronic device may submit such a request to one or more identification system electronic devices.

At operation 320, the electronic device may provide information to identify the requestor. The information may include one or more digital representations of biometrics that may be compared against stored biometric data, passwords and/or other credentials that may be compared against stored credentials, and so on.

At operation 330, the electronic device may receive one or more formatted attestations. The electronic device may store the formatted attestation.

At operation 340, the electronic device may determine whether or not a reader request is received. If not, the flow may return to operation 340 where the electronic device may again determine whether or not a reader request is received. Otherwise, the flow may proceed to operation 350.

At operation 350, the electronic device may provide the formatted attestation. The flow may then return to operation 340 where the electronic device may again determine whether or not a reader request is received.

In various examples, this example method 300 may be implemented using a group of interrelated software modules or components that perform various functions discussed herein. These software modules or components may be executed within a cloud network and/or by one or more computing devices, such as the attesting device 101, the identification system electronic device 102, and/or the reader device 103 of FIG. 1.

Although the example method 300 is illustrated and described as including particular operations performed in a particular order, it is understood that this is an example. In various implementations, various orders of the same, similar, and/or different operations may be performed without departing from the scope of the present disclosure.

For example, the method 300 is illustrated and described as receiving one or more formatted attestations. However, it is understood that this is an example. In some examples, the attestation may not be formatted. Various configurations are possible and contemplated without departing from the scope of the present disclosure.

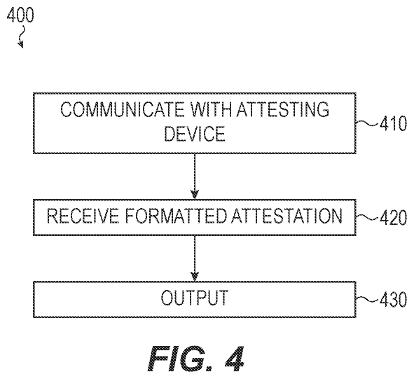

FIG. 4 is a flow chart illustrating a third example method 400 for peer-to-peer identity verification. The method 400 may be performed by the system 100 of FIG. 1.

At operation 410, an electronic device (such as the reader device 103 of FIG. 1) may communicate with one or more attesting devices. Such communication may include requesting one or more attestations. Such communication may include a near field communication tap, a Bluetooth™ communication, a text message, and so on.

At operation 420, the electronic device may receive one or more formatted attestations. The electronic device may receive the formatted attestation from the device to which the electronic device communicated and/or another device.

At operation 430, the electronic device may output the formatted attestation. Outputting the formatted attestation may be performed using one or more output components, such as one or more displays, speakers, printers, and so on.

In various examples, this example method 400 may be implemented using a group of interrelated software modules or components that perform various functions discussed herein. These software modules or components may be executed within a cloud network and/or by one or more computing devices, such as the attesting device 101, the identification system electronic device 102, and/or the reader device 103 of FIG. 1.

Although the example method 400 is illustrated and described as including particular operations performed in a particular order, it is understood that this is an example. In various implementations, various orders of the same, similar, and/or different operations may be performed without departing from the scope of the present disclosure.

For example, the method 400 illustrated and described as receiving one or more formatted attestations. However, it is understood that this is an example. In some examples, the attestation may not be formatted and the electronic device may format such. Various configurations are possible and contemplated without departing from the scope of the present disclosure.

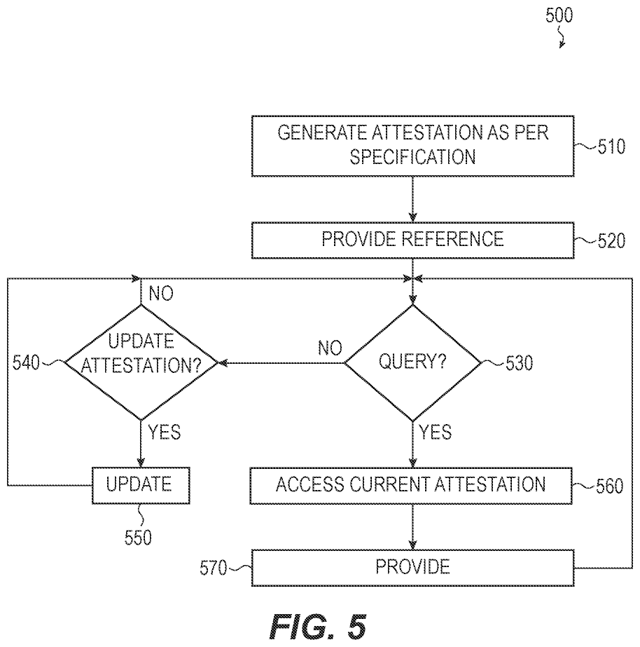

FIG. 5 is a flow chart illustrating a fourth example method 500 for peer-to-peer identity verification. The method 500 may be performed by the system 100 of FIG. 1.

At operation 510, an electronic device (such as the identification system electronic device 102 of FIG. 1) may generate one or more attestations as per one or more specifications. Such specifications may be received in association with one or more attestation requests. Such specifications and/or requests may be received from one or more attesting devices.

At operation 520, the electronic device may provide one or more references to the attestations. The reference may be a QR code, a link, and/or another mechanism.

At operation 530, the electronic device may determine whether or not one or more queries are received. The queries may be for the attestation and may be made using the reference. If not, the flow may proceed to operation 540 where the electronic device may determine whether or not to update the attestation. Otherwise, the flow may proceed to operation 560 where the electronic device may access the current attestation.

At operation 540, if the electronic device determines to update the attestation, the flow may proceed to operation 550 where the electronic device may update the attestation before the flow returns to operation 530 where the electronic device may again determine whether or not one or more queries are received. The electronic device may update the attestation if identity information used to generate the attestation has been updated since the attestation was generated and/or is otherwise out of date. Otherwise, the flow may return directly to operation 530.

At operation 560, after the electronic device accesses the current attestation, the flow may proceed to operation 570 where the electronic device may provide the current attestation before the flow returns to operation 530 where the electronic device may again determine whether or not one or more queries are received.

In various examples, this example method 500 may be implemented using a group of interrelated software modules or components that perform various functions discussed herein. These software modules or components may be executed within a cloud network and/or by one or more computing devices, such as the attesting device 101, the identification system electronic device 102, and/or the reader device 103 of FIG. 1.

Although the example method 500 is illustrated and described as including particular operations performed in a particular order, it is understood that this is an example. In various implementations, various orders of the same, similar, and/or different operations may be performed without departing from the scope of the present disclosure.

For example, the method 500 is illustrated and described as determining whether or not to update the attestation after determining that a query has not been received. However, it is understood that this is an example. In various implementations, the attestation may be updated at any time. Various configurations are possible and contemplated without departing from the scope of the present disclosure.

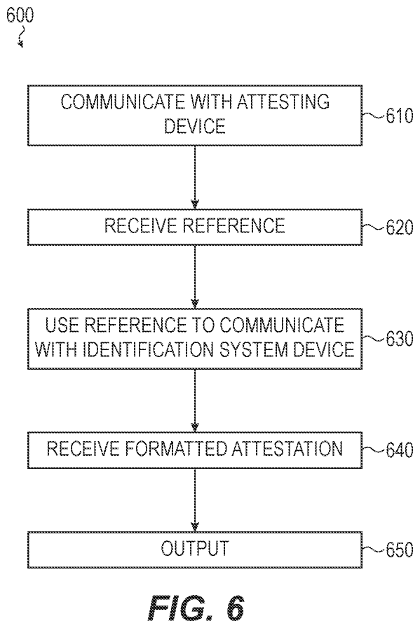

FIG. 6 is a flow chart illustrating a fifth example method 600 for peer-to-peer identity verification. The method 600 may be performed by the system 100 of FIG. 1.

At operation 610, an electronic device (such as the reader device 103 of FIG. 1) may communicate with one or more attesting devices. Such communication may include a near field communication tap, a Bluetooth™ communication, a text message, and so on. The communication may include one or more requests for one or more attestations.

At operation 620, the electronic device may receive one or more references. The reference may be a reference to one or more attestations. The reference may be a QR code, a link, and/or another mechanism.

At operation 630, the electronic device may use the reference to communicate with one or more identification system electronic devices. The communication may include a request for one or more references.

At operation 640, the electronic device may receive one or more formatted attestations. The electronic device may receive the formatted attestation in response to use of the reference.

At operation 650, the electronic device may output the formatted attestation. Outputting the formatted attestation may be performed using one or more output components, such as one or more displays, speakers, printers, and so on.

In various examples, this example method 600 may be implemented using a group of interrelated software modules or components that perform various functions discussed herein. These software modules or components may be executed within a cloud network and/or by one or more computing devices, such as the attesting device 101, the identification system electronic device 102, and/or the reader device 103 of FIG. 1.

Although the example method 600 is illustrated and described as including particular operations performed in a particular order, it is understood that this is an example. In various implementations, various orders of the same, similar, and/or different operations may be performed without departing from the scope of the present disclosure.

For example, the method 600 is illustrated and described as outputting one or more formatted attestations. However, it is understood that this is an example. In some examples, the attestation may not be formatted. Various configurations are possible and contemplated without departing from the scope of the present disclosure.

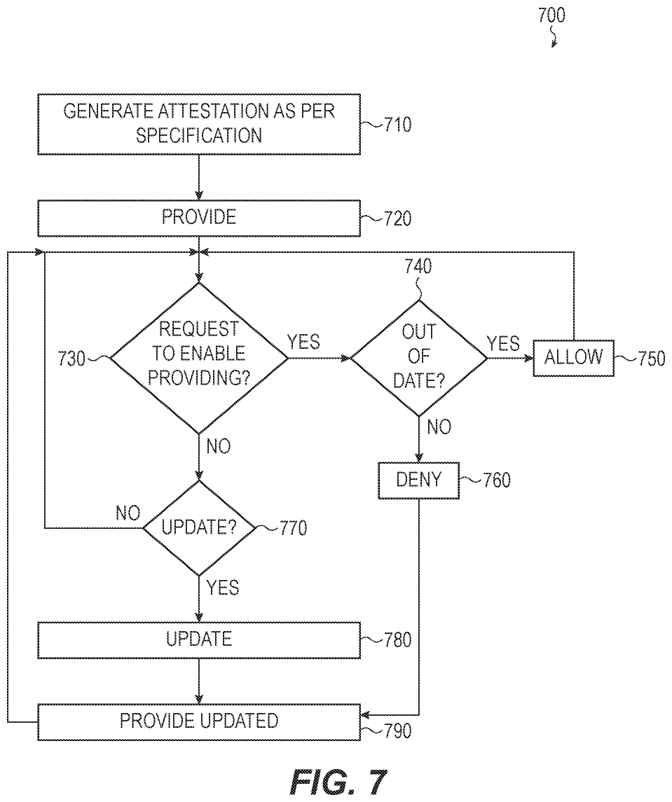

FIG. 7 is a flow chart illustrating a sixth example method 700 for peer-to-peer identity verification. The method 700 may be performed by the system 100 of FIG. 1.

At operation 710, an electronic device (such as the identification system electronic device 102 of FIG. 1) may generate one or more attestations as per one or more specifications. At operation 720, the electronic device may provide the generated attestation.

At operation 730, the electronic device may determine whether or not a request to enable providing of the provided generated attestation is received. For example, the generated attestation may be provided to an attesting device and the electronic device may determine whether or not a request to enable the attesting device to provide the provided generated attestation to one or more other devices, such as a reader device, is received. If so, the flow may proceed to operation 740. Otherwise, the flow may proceed to operation 770.

At operation 740, the electronic device may determine whether or not the provided generated attestation is out of date. If so, the flow may proceed to operation 760 where the electronic device may deny enabling of providing of the provided generated attestation before the flow proceeds to operation 790 where the electronic device may provide an updated attestation that the requesting device may be enabled to provide and/or may request to be enabled to provide. Otherwise, the flow may proceed to operation 750 where the electronic device may enable providing of the provided generated attestation before the flow returns to operation 730 where the electronic device again determines whether or not a request to enable providing of the provided generated attestation.

At operation 770, the electronic device may determine whether or not to update the attestation. If not, the flow may return to operation 730 where the electronic device again determines whether or not a request to enable providing of the provided generated attestation. Otherwise, the flow may proceed to operation 780 where the electronic device may update the attestation. The flow may then proceed to operation 790 where the electronic device may provide the updated attestation.

In various examples, this example method 700 may be implemented using a group of interrelated software modules or components that perform various functions discussed herein. These software modules or components may be executed within a cloud network and/or by one or more computing devices, such as the attesting device 101, the identification system electronic device 102, and/or the reader device 103 of FIG. 1.

Although the example method 700 is illustrated and described as including particular operations performed in a particular order, it is understood that this is an example. In various implementations, various orders of the same, similar, and/or different operations may be performed without departing from the scope of the present disclosure.

For example, the method 700 is illustrated and described as proceeding from operation 760 to operation 790. However, it is understood that this is an example. In various implementations, the flow may proceed from operation 760 to operation 780 and then to operation 790. Various configurations are possible and contemplated without departing from the scope of the present disclosure.

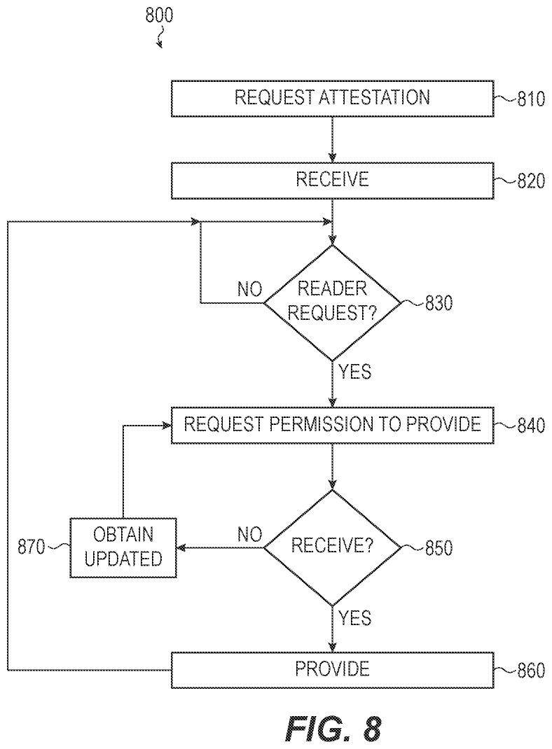

FIG. 8 is a flow chart illustrating a seventh example method 800 for peer-to-peer identity verification. The method 800 may be performed by the system 100 of FIG. 1.

At operation 810, an electronic device (such as the attesting device 101 of FIG. 1) may request one or more attestations. The flow may then proceed to operation 820 where the electronic device may receive the requested attestation.

At operation 830, the electronic device may determine whether or not one or more reader requests are received. If not, the flow may return to operation 830 where the electronic device may again determine whether or not one or more reader requests are received. Otherwise, the flow may proceed to operation 840 where the electronic device may request permission to provide the attestation.

At operation 850, the electronic device may determine whether or not permission is received. If not, the flow may flow to operation 870 where the electronic device may receive an updated attestation before the flow returns operation 840 where the electronic device may request permission to provide the updated attestation. Otherwise, the flow may proceed to operation 860 where the electronic device may provide the attestation before the flow returns to operation 830 where the electronic device may again determine whether or not one or more reader requests are received.

In various examples, this example method 800 may be implemented using a group of interrelated software modules or components that perform various functions discussed herein. These software modules or components may be executed within a cloud network and/or by one or more computing devices, such as the attesting device 101, the identification system electronic device 102, and/or the reader device 103 of FIG. 1.

Although the example method 800 is illustrated and described as including particular operations performed in a particular order, it is understood that this is an example. In various implementations, various orders of the same, similar, and/or different operations may be performed without departing from the scope of the present disclosure.

For example, the method 800 is illustrated and described as proceeding from operation 870 to operation 840. However, it is understood that this is an example. In various implementations, the flow may proceed from operation 870 to operation 860. Various configurations are possible and contemplated without departing from the scope of the present disclosure.

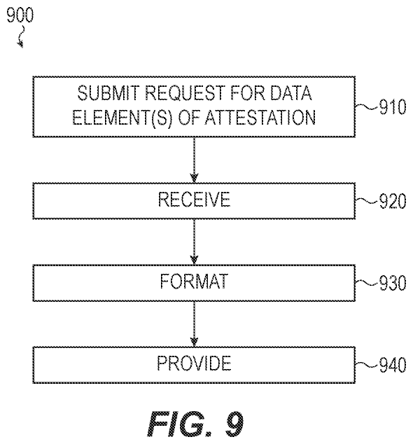

FIG. 9 is a flow chart illustrating an eighth example method 900 for peer-to-peer identity verification. The method 900 may be performed by the system 100 of FIG. 1.

At operation 910, an electronic device (such as the identity system electronic device 102 of FIG. 1) may submit one or more requests for one or more data elements of one or more attestations. Such data elements may include one or more names, phone numbers, addresses, email addresses, professional licenses, professional license statuses, education statuses, certification statues, financial statuses, insurance statuses, biographic information (e.g. name, address, date of birth), additional metadata (such as memberships, loyalty cards, employment history, and so on) and/or any other information associated with the identity of the person.

At operation 920, the electronic device may receive the data elements. At operation 930, the electronic device may format an attestation using the received data elements. The electronic device may format the attestation according to one or more received formatting specifications. At operation 940, the electronic device may provide the formatted attestation. The electronic device may provide the formatted attestation to one or more requesting devices, such as an attesting device, a reader device, and so on.

In various examples, this example method 900 may be implemented using a group of interrelated software modules or components that perform various functions discussed herein. These software modules or components may be executed within a cloud network and/or by one or more computing devices, such as the attesting device 101, the identification system electronic device 102, and/or the reader device 103 of FIG. 1.

Although the example method 900 is illustrated and described as including particular operations performed in a particular order, it is understood that this is an example. In various implementations, various orders of the same, similar, and/or different operations may be performed without departing from the scope of the present disclosure.

For example, the method 900 is illustrated and described as formatting the attestation. However, it is understood that this is an example. In various implementations, such an operation may be omitted. Various configurations are possible and contemplated without departing from the scope of the present disclosure.

In various implementations, an identification system electronic device may include a non-transitory storage medium that stores instructions and a processor. The processor may execute the instructions to verify identity information for a person; receive a request to generate an attestation for the person from an attesting device; upon identifying the person using information received from the attesting device, generate the attestation using a portion of the identity information specified in the request; and provide the attestation.

In some examples, the processor may further execute the instructions to provide the attestation to the attesting device. In a number of examples, the processor may further execute the instructions to provide a reference to the attestation to the attesting device and the attestation to a reader device that may communicate with the processor using the reference. In various examples, the request may specify a format for the attestation. In some examples, the attestation may include at least one of a license status of the person, an education status of the person, a certification status of the person, or an insurance status of the person.

In a number of examples, the processor may further execute the instructions to determine whether to authorize the attesting device to provide the attestation stored by the attesting device in response to an authorization request. In some such examples, the processor may further execute the instructions to determine to authorize the attesting device to provide the attestation stored by the attesting device upon determining that the attestation is up to date. In various such examples, the processor may further execute the instructions to generate an updated attestation upon determining that the attestation is out of date in response to the authorization request. In a number of such examples, the processor may further execute the instructions to provide the updated attestation to the attesting device. In various such examples, the processor may further execute the instructions to authorize the attesting device to provide the updated attestation in response to the authorization request.

In some implementations, an attesting device may include a non-transitory storage medium that stores instructions and a processor. The processor may execute the instructions to submit a request to generate an attestation for a person to an identification system electronic device that maintains identity information for the person, the request specifying a portion of the identity information; receive a response from the identification system electronic device that enables access to the attestation; and provide the access to the attestation using the response.

In a number of examples, the processor may further execute the instructions to provide the access to the attestation by providing the attestation to a reader device. In various such examples, the processor may further execute the instructions to provide the attestation to the reader device in response to a communication from the reader device. In some such examples, the communication may be a near field communication tap.

In various examples, the processor may further execute the instructions to provide the access to the attestation by providing a reference to the attestation to a reader device. In some such examples, the reference may be a quick response code.

In various examples, the processor may further execute the instructions to format the attestation using the portion of the identity information included in the response.

In a number of embodiments, a reader device may include a non-transitory storage medium that stores instructions and a processor. The processor may execute the instructions to communicate with an attesting device; receive an attestation for a person generated, in response to a request from the attesting device, by an identification system electronic device that maintains verified identity information for the person, the request specifying a portion of the verified identity information to include in the attestation; and output the attestation.

In various examples, the processor may further execute the instructions to receive the attestation from the attesting device. In some examples, the processor may further execute the instructions to receive a reference to the attestation from the attesting device and use the reference to obtain the attestation from the identification system electronic device.

Although the above illustrates and describes a number of embodiments, it is understood that these are examples. In various implementations, various techniques of individual embodiments may be combined without departing from the scope of the present disclosure.

As described above and illustrated in the accompanying figures, the present disclosure relates to peer-to-peer identity verification. People enrolled in the identification system use one or more electronic devices to interact with one or more electronic devices of the identification system in order to provide assertions regarding aspects of their identity stored in the identification system in a peer-to-peer fashion. The people, who may provide proof of their identity, may be able to specify the information that is to be provided, indicate how the information is to be formatted, and then provide one or more other people one or more mechanisms to access the formatted, specified information. In this way, the people may use the identification system to prove any number of different aspects of their identity to any number of different people without requiring different configurations for the different people and/or different information to be provided.

The present disclosure recognizes that biometric and/or other personal data is owned by the person from whom such biometric and/or other personal data is derived. This data can be used to the benefit of those people. For example, biometric data may be used to conveniently and reliably identify and/or authenticate the identity of people, access securely stored financial and/or other information associated with the biometric data, and so on. This may allow people to avoid repeatedly providing physical identification and/or other information.

The present disclosure further recognizes that the entities who collect, analyze, store, and/or otherwise use such biometric and/or other personal data should comply with well-established privacy policies and/or privacy practices. Particularly, such entities should implement and consistently use privacy policies and practices that are generally recognized as meeting or exceeding industry or governmental requirements for maintaining security and privately maintaining biometric and/or other personal data, including the use of encryption and security methods that meets or exceeds industry or government standards. For example, biometric and/or other personal data should be collected for legitimate and reasonable uses and not shared or sold outside of those legitimate uses. Further, such collection should occur only after receiving the informed consent. Additionally, such entities should take any needed steps for safeguarding and securing access to such biometric and/or other personal data and ensuring that others with access to the biometric and/or other personal data adhere to the same privacy policies and practices. Further, such entities should certify their adherence to widely accepted privacy policies and practices by subjecting themselves to appropriate third party evaluation.

Additionally, the present disclosure recognizes that people may block the use of, storage of, and/or access to biometric and/or other personal data. Entities who typically collect, analyze, store, and/or otherwise use such biometric and/or other personal data should implement and consistently prevent any collection, analysis, storage, and/or other use of any biometric and/or other personal data blocked by the person from whom such biometric and/or other personal data is derived.

In the present disclosure, the methods disclosed may be implemented as sets of instructions or software readable by a device. Further, it is understood that the specific order or hierarchy of steps in the methods disclosed are examples of sample approaches. In other embodiments, the specific order or hierarchy of steps in the method can be rearranged while remaining within the disclosed subject matter. The accompanying method claims present elements of the various steps in a sample order, and are not necessarily meant to be limited to the specific order or hierarchy presented.

The described disclosure may be provided as a computer program product, or software, that may include a non-transitory machine-readable medium having stored thereon instructions, which may be used to program a computer system (or other electronic devices) to perform a process according to the present disclosure. A non-transitory machine-readable medium includes any mechanism for storing information in a form (e.g., software, processing application) readable by a machine (e.g., a computer). The non-transitory machine-readable medium may take the form of, but is not limited to, a magnetic storage medium (e.g., floppy diskette, video cassette, and so on); optical storage medium (e.g., CD-ROM); magneto-optical storage medium; read only memory (ROM); random access memory (RAM); erasable programmable memory (e.g., EPROM and EEPROM); flash memory; and so on.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art that many modifications and variations are possible in view of the above teachings.

What is claimed is:

1. An identification system electronic device, comprising:
a non-transitory storage medium that stores instructions; and
a processor that executes the instructions to:
verify identity information for a person;
receive a request to generate an attestation for the person from an attesting device;
upon identifying the person using information received from the attesting device, generate the attestation using a portion of the identity information specified in the request; and
provide the attestation.

2. The identification system electronic device of claim 1, wherein the processor further executes the instructions to provide the attestation to the attesting device.

3. The identification system electronic device of claim 1, wherein the processor further executes the instructions to:
provide a reference to the attestation to the attesting device; and
provide the attestation to a reader device that communicates with the processor using the reference.

4. The identification system electronic device of claim 1, wherein the request specifies a format for the attestation.

5. The identification system electronic device of claim 1, wherein the attestation includes at least one of:
a license status of the person;
an education status of the person;
a certification status of the person; or
an insurance status of the person.

6. The identification system electronic device of claim 1, wherein the processor further executes the instructions to determine whether to authorize the attesting device to provide the attestation stored by the attesting device in response to an authorization request.

7. The identification system electronic device of claim 6, wherein the processor further executes the instructions to determine to authorize the attesting device to provide the attestation stored by the attesting device upon determining that the attestation is up to date.

8. The identification system electronic device of claim 6, wherein the processor further executes the instructions to generate an updated attestation upon determining that the attestation is out of date in response to the authorization request.

9. The identification system electronic device of claim 8, wherein the processor further executes the instructions to provide the updated attestation to the attesting device.

10. The identification system electronic device of claim 9, wherein the processor further executes the instructions to authorize the attesting device to provide the updated attestation in response to the authorization request.

11. An attesting device, comprising:
a non-transitory storage medium that stores instructions; and
a processor that executes the instructions to:
submit a request to generate an attestation for a person to an identification system electronic device that maintains identity information for the person, the request specifying a portion of the identity information;
receive a response from the identification system electronic device that enables access to the attestation; and
provide the access to the attestation using the response.

12. The attesting device of claim 11, wherein the processor further executes the instructions to provide the access to the attestation by providing the attestation to a reader device.

13. The attesting device of claim 12, wherein the processor further executes the instructions to provide the attestation to the reader device in response to a communication from the reader device.

14. The attesting device of claim 13, wherein the communication is a near field communication tap.

15. The attesting device of claim 11, wherein the processor further executes the instructions to provide the access to the attestation by providing a reference to the attestation to a reader device.

16. The attesting device of claim 15, wherein the reference is a quick response code.

17. The attesting device of claim 11, wherein the processor further executes the instructions to format the attestation using the portion of the identity information included in the response.

18. A reader device, comprising:
a non-transitory storage medium that stores instructions; and
a processor that executes the instructions to:
communicate with an attesting device;
receive an attestation for a person generated, in response to a request from the attesting device, by an identification system electronic device that maintains verified identity information for the person, the request specifying a portion of the verified identity information to include in the attestation; and
output the attestation.

19. The reader device of claim 18, wherein the processor further executes the instructions to receive the attestation from the attesting device.

20. The reader device of claim 18, wherein the processor further executes the instructions to:
receive a reference to the attestation from the attesting device; and
use the reference to obtain the attestation from the identification system electronic device.
